(19) United States
(12) Patent Application Publication
(10) Pub. No.: US 2015/0351368 A1
(43) Pub. Date: Dec. 10, 2015

(54) Pet Waste Collection Disposal Device

(71) Applicant: Cedric K Olivera, Scotch Plains, NJ (US)

(72) Inventor: Cedric K Olivera, Scotch Plains, NJ (US)

(21) Appl. No.: 14/816,938

(22) Filed: Aug. 3, 2015

Related U.S. Application Data
(63) Continuation of application No. 13/831,200, filed on Mar. 14, 2013, now abandoned.

(51) Int. Cl. A01K 23/00

(52) U.S. Cl. CPC A01K 23/005

(57) ABSTRACT

A pet waste collection and disposal device may be utilized to safely dispose of animal waste. The device includes a handle and actuation component, an elongated shaft component, and a capture mechanism.

### BACKGROUND OF THE INVENTION

1. Field of the Invention

The present invention relates to refuse collecting devices, and more particularly to a portable, hand held, solid pet waste collection and disposal device.

2. Discussion of the Related Art

Our population is increasingly being exposed to health risks. People may spread and contract potentially serious illnesses by merely failing to wash their hands after touching seemingly innocuous objects such as grocery goods, and they can develop potentially life threatening diseases by picking up and handling improperly disposed of waste. Moreover, viruses that were once thought to be confined to animals are infecting humans who come into contact with a sick animal or the sick animal's waste. Public concern over sanitation is accordingly escalating and individuals are consistently adopting more stringent sanitary practices. This is especially true when they are picking up refuse or their pet's solid waste, as they understand that direct or even indirect contact with the refuse and/or waste may pose potential health concerns.

As is well recognized, the population of domesticated pets such as dogs and cats is steadily increasing and particularly so in urban areas. Therefore, the effective retrieval and disposal of solid animal waste deposits has, due to the potential risk to public health created by resultant unsanitary conditions as well as general inconvenience to the public, become a matter of considerable official concern. In attempts to combat the problem, many localities and municipalities have enacted ordinances which make pet owners liable to a fine for failure to clean up solid animal waste or excrement left by their pets. Even in communities which do not have such local ordinances, many pet owners who have a sense of civic responsibility do undertake to clean up after their pets.

An extensive market exits for devices for the collection of solid pet waste. Common tools such as shovels, trowels and bags continue to be utilized, but more sophisticated devices are increasing in popularity. These more sophisticated devices typically include a shaft with an actuating device that is utilized to clamp or scoop up the solid waste from the ground. These devices also typically require that the user attach a bag or other disposal means to the clamp or scoop end prior to picking up the waste. However, these devices are usually one or more of cumbersome, overly complex, difficult to utilize and/or often may require some direct or indirect contact with the waste, due to its contact with the ground, for complete disposal. Accordingly, there exists a need for a simple, inexpensive and easy to utilize waste removal device which not only permits removal of the waste, but also includes a sanitary disposable container.

### SUMMARY OF THE INVENTION

The pet waste collection and disposal device of the present invention overcomes a number of disadvantages associated with the prior art devices as briefly described above.

The pet waste collection and disposal device of the present invention comprises an elongated shaft having a first and a second end, a handle and actuation mechanism mounted or connected to the first end of the elongated shaft, and a capture mechanism mounted or connected to the second end of the elongated shaft. The handle and actuation mechanism is preferably operatively associated with the capture mechanism. The pet waste collection and disposal device is configured to allow the user to capture the solid waste prior to it contacting any other surface such as the ground. In other words, the capture mechanism is sized and configured to easily capture the solid waste while the animal is in the process of relieving itself without disturbing the animal. In this way, the pet waste collection and disposal device allows for solid waste collection and disposal with minimal risk of exposure to the waste as the waste is wholly contained within, and only makes contact with the interior portion of the capture mechanism.

More specifically, the capture mechanism of the pet waste collection and disposal device comprises a frame structure to which a containment vessel, for example, a sealable, disposable plastic bag, is attached. The frame structure is configured such that it secures the containment vessel in a manner that the frame structure itself is prevented from contacting the waste and only the interior of the containment vessel may come into contact with the waste. Once the waste is collected, the user simply closes and seals the containment vessel via the actuation mechanism and removes it from the frame structure for proper disposal. Since the waste does not contact the exterior of the containment vessel, the user may dispose of the containment vessel without fear of making contact with the waste contained therein.

The pet waste collection and disposal device of the present invention is a simple to operate, lightweight and inexpensive means for solid pet waste collection and disposal. The elongated shaft may be manufactured from any number of suitable lightweight and strong materials. In addition, the elongated shaft may comprise a number of locking telescoping sections that allow the user to more comfortably utilize the device. In addition, the capture mechanism may be configured with a retractable frame that allows the user to more easily carry the device, for example, in his or her pocket or other carrying case. The device allows a pet owner to safely collect and dispose of their pet's solid waste. The containment vessel may also be scented to ensure that the entire process, including disposal, is less offensive. For example, if the containment vessels are to be disposed of in one's home garbage receptacle, having a scented containment vessel may preclude malodorous emanations from escaping the receptacle.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 is a diagrammatic representation of one exemplary embodiment of a pet waste collection and disposal device in accordance with the present invention.

FIG. 2 is a diagrammatic representation of an exemplary telescoping elongated shaft in accordance with the present invention.

FIG. 3 is a diagrammatic representation of an exemplary retractable frame structure in accordance with the present invention.

FIG. 4 is a diagrammatic representation of an exemplary actuation means connected to the frame structure in accordance with the present invention.

FIG. 5 is a diagrammatic representation of an exemplary actuation means connected to the draw string mechanism in accordance with the present invention.

FIG. 6 is a diagrammatic representation of a pet waste collection and disposal device in accordance with an exemplary embodiment of the present invention.

### DETAILED DESCRIPTION OF THE PREFERRED EMBODIMENTS

The pet waste collection and disposal device of the present invention is an easy to utilize, self-contained device for the safe and easy collection and disposal of solid pet waste. The device is designed to be carried by an individual and deployed when the pet or animal is ready to relieve itself. The device is specifically configured to capture the solid waste while the animal is in the process of relieving itself rather than for picking up the waste after it is on the ground. The device is also designed or configured not interfere with or distract the animal when being utilized. Once the waste is collected, the individual simply utilizes the device to seal the waste for proper disposal. While this device may be utilized with any pet the user desires and for liquid waste as well as solid waste, it is understood that users of this device will typically utilize the device with their dogs and only for the collection of solid waste.

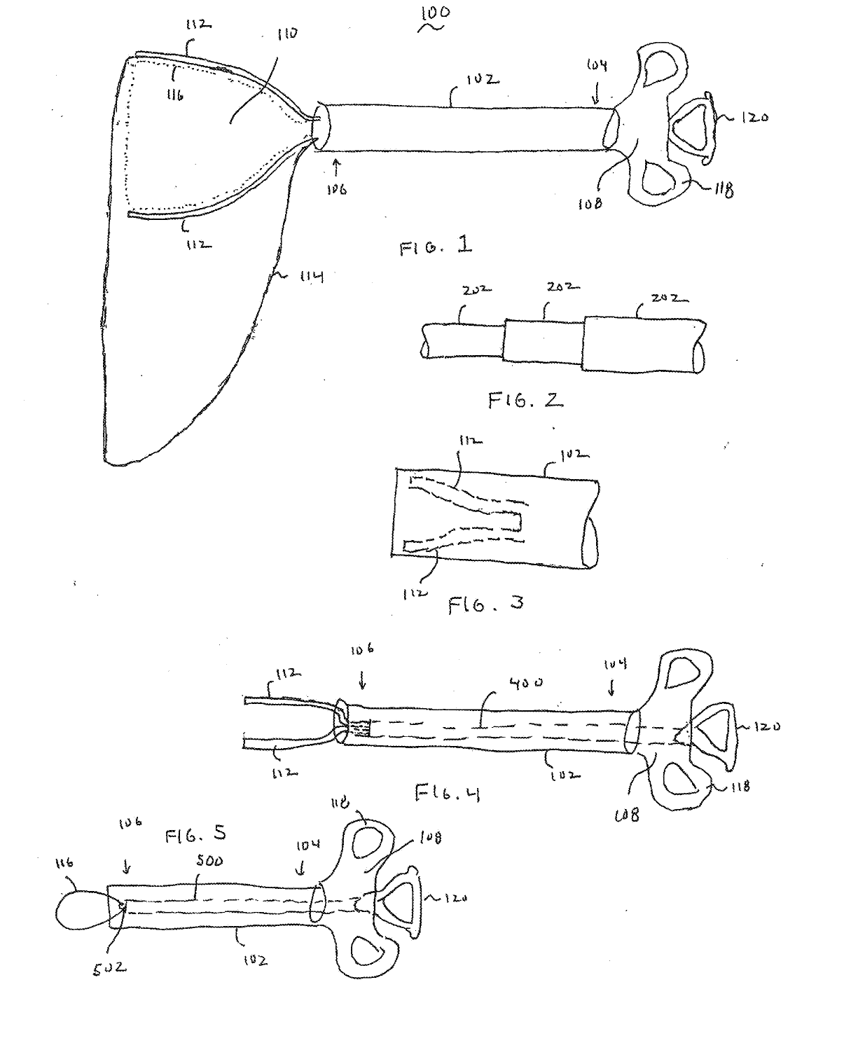

Referring to FIG. 1, there is illustrated an exemplary pet waste collection and disposal device 100 in accordance with the present invention. In this exemplary embodiment, the device 100 comprises an elongated shaft 102 having a first end 104 and a second end 106, a handle and actuation mechanism 108 mounted or connected to the first end 104 of the elongated shaft 102, and a capture mechanism 110 mounted or connected to the second end 106 of the elongated shaft 102. The handle and actuation mechanism 108 is operatively associated with the capture mechanism 110 as described in detail subsequently. The device 100 may be configured as a modular device wherein each of the components may be removably connected to one another, the device 100 may be configured as a single unitary structure wherein all the components are permanently connected to one another, or the device 100 may be configured as a combination of removable or permanently connected components.

In the exemplary embodiment illustrated in FIG. 1, the elongated shaft 102 comprises a substantially tubular member that may be manufactured from any number of lightweight and strong materials, including metals, metal alloys, polymeric materials such as plastics, and composite materials. The elongated shaft 102 preferably comprises a corrosion resistant material, and is sized so that an average sized individual does not have to bend over while utilizing the device 100. In an alternate exemplary embodiment, the elongated shaft 102 may comprise telescoping sections 202 as illustrated in FIG. 2. The telescoping sections 202 may be configured to provide an adjustable length device 100. For example, the telescoping sections 202 may comprise threaded locking mechanisms that allow one section 202 to advance through or from another section 202 when the locking mechanisms are open, until the device 100 is at the desired length and then the telescoping sections 202 may be locked in place to create a rigid elongated shaft 102. The elongated shaft 102 may also be shortened to a single section 202, utilizing the same process, for ease of storage and/or for ease of carrying. Although a threaded locking mechanism is described above, any suitable locking mechanism may be utilized in accordance with this exemplary embodiment. In either exemplary embodiment, the elongated shaft 102 is preferably strong enough to support the forces, including torsional forces, acting on it when the capture mechanism 110 is full.

A substantially tubular member is utilized for the elongated shaft 102 so that any connections between the capture mechanism 110 and the handle and actuation mechanism 108 are contained within or internal to the elongated shaft 102. In other words, a substantially tubular member allows for the working connections between the handle and actuation mechanism 108 and the capture mechanism 110, as described in greater detail subsequently, to be housed within the tubular shaft and not external to the device. This makes the device easier to care for and maintain. In addition, a tubular shaft reduces the weight of the device 100. In alternate exemplary embodiments, the working connections may be made external to the elongated shaft 102, or a combination of internal and external connections.

The capture mechanism 110 comprises a frame structure 112 that supports and/or secures a containment vessel 114. The containment vessel 114 may comprise any suitable structure for capturing, securing and safely storing solid waste. The frame structure 112 and the containment vessel 114 may be configured such that the frame structure 112 is prevented from making direct contact with the solid waste at any time, and only the interior of the containment vessel 114 comes into contact with the solid waste. The frame structure 112 may comprise any suitable shape, size and/or configuration that ensures that the solid waste is easily collected while the animal is relieving itself and without disturbing the animal.

In one exemplary embodiment, the frame structure 112 may comprise two rails that are fixedly connected to the second end 106 of the elongated shaft 102 and form a substantially U-shaped structure as illustrated in FIG. 1. In an alternate exemplary embodiment, the frame structure 112 may comprise two rails that are movably connected to the second end 106 of the elongated shaft 102. In this exemplary embodiment, the handle and actuation mechanism 108 may be utilized through an actuator to deploy the frame structure 112 from within the elongated shaft 102 when being utilized for collection as illustrated in FIG. 1, and then to retract the frame structure 112 into the elongated shaft 102 when not being utilized as illustrated in FIG. 3. Any simple actuator, for example, a tie rod may be utilized to deploy and retract the frame structure 112. If the frame structure 112 is retractable, then it preferably comprises a material that has spring like properties so that it may retain its deployed shape and size when it is deployed and a much smaller shape when it is retracted into the elongated shaft 102. Alternately, it may be configured with a hinge or linkage type structure so that it may be retracted into the elongated shaft 102. The frame structure 112 may be formed from any suitable material, including metals, metal alloys, polymeric materials such as plastics, and composites. Preferably, the material is corrosion resistant. The frame structure 112 may comprise any suitable means to secure the containment vessel 114. As set forth above, the containment vessel 114 protects the frame structure 112 from contamination. In addition, once the solid waste is collected, the containment vessel 114 has to be sealed and removed from the frame structure 112. Accordingly, the frame structure 112 preferably facilitates containment vessel 114 removal and replacement.

The containment vessel 114 may comprise any suitable container or pouch for securing solid waste. In one exemplary embodiment, the containment vessel 114 comprises a bag that fits over the frame structure 112 to protect the frame structure 112. For example, the edge of the bag may simply be everted to create a pocket that engages the frame structure 112 as illustrated in FIG. 1. In this manner, the frame structure 112 is protected from direct contact and only the interior of the bag comes into contact with the solid waste. In addition, the bag may then be easily removed from the frame structure 112. The plastic bag is preferably sealable for safe disposal and formed from a material that is suitable for the disposal of biological waste. The plastic bag may be sealed by any suitable means, for example, a draw string or gathers. In the illustrated exemplary embodiment, the plastic bag comprises a draw string mechanism 116 that allows the user, via the handle and actuation mechanism 108, to close and seal the plastic bag when waste collection is complete. Once the bag is sealed, it may be removed from the frame structure 112 and disposed of in any suitable manner. The draw string mechanism 116 may be actuated by the handle and control mechanism 108 by any suitable means. For example, a tie rod with a hook may be connected to the handle and control mechanism 108 in such a manner that allows a user to cinch the bag when it is full. In a preferred exemplary embodiment, the bag may be scented with any number of pleasing scents. A scented bag or containment vessel 114 is preferable in that it may serve to mask any malodorous emanations therefrom. The bag may be scented via any suitable process as is known to one skilled in the relevant art.

In alternate exemplary embodiments, the frame structure 112 may comprise holding means, such as grooves, configured to secure the containment vessel 114. These grooves may be configured such that a portion of the containment vessel 114 is secured therein by frictional engagement or via an interference fit. In any design; however, the containment vessel 114 preferably prevents contact between the solid waste and the frame structure 112 as well as only allowing waste contact with the interior portion of the containment vessel 114.

The handle and actuation mechanism 108 may comprise any suitable configuration for either one or two handed operation. The exemplary handle and actuation mechanism 108 comprises a finger grip section 118 and an actuator handle 120 as illustrated in FIG. 1. The exemplary handle and actuation mechanism 108 may be formed from any suitable material or combination of materials that provides for a comfortable, non-slip grip, including metals, metal alloys, polymers such as plastics, and composites. The material preferably comprise a corrosion resistant material. The finger grip section 118 may be attached to the elongated shaft 102 by any suitable means. For example, it may be removably attached via a threaded connection or it may be permanently attached via a welded or glued joint. The actuator handle 120 may comprise any suitable configuration and is configured to manipulate one or more actuation means by the user simply moving the actuator handle 120 linearly or rotationally as described in greater detail subsequently. In one exemplary embodiment, the actuator handle 120 is slidably engaged to the finger grip section 118 for both linear movement and rotational movement.

In an alternate embodiment illustrated in FIG. 6, actuation mechanism 108 includes a thimble style handle 125 operatively connected to actuaion means 400. In this embodiment the finger grip section 118 is replaced by a collar 130 which the user may employ to grip the device while pushing or pulling handle 125.

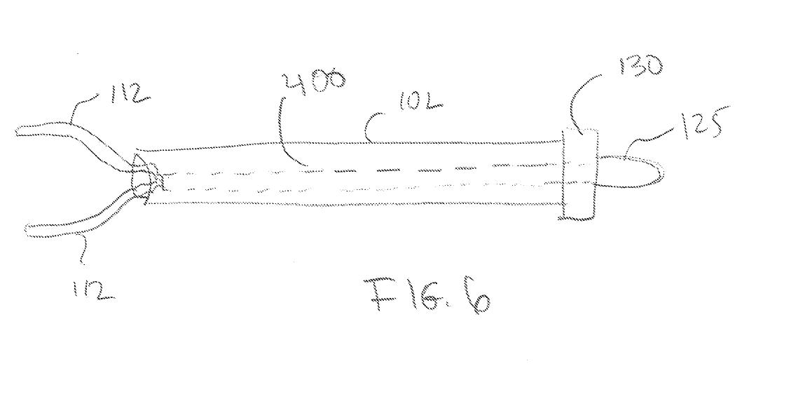

Referring now to FIG. 4, there is illustrated, partially in phantom, a single actuation means 400 connected to the frame structure 112. The connections may be made by any suitable means. In this illustrated exemplary embodiment, the actuation means 400 comprises a tie rod. By drawing back the actuator handle 120 relative to the finger grip section 118 and the elongated shaft 102, the frame structure 112 may be retracted. Conversely, if the frame structure 112 is already retracted, simply pushing the actuator handle 120 forward relative to the finger grip section 118 and the elongated tube 102 will deploy the frame structure 112. In alternate exemplary embodiments, a cable or similar structure may be utilized as the actuation means. As cables and similar devices work in tension and not compression, pulley systems may be required to obtain the required action.

Referring now to FIG. 5, there is illustrated, partially in phantom, a single actuation means 500 connected to the draw string 116 mechanism via a connection mechanism 502. Once again the connections may be made by any suitable means. In this illustrated exemplary embodiment, the actuation means 500 comprises a tie rod. By drawing back the actuator handle 120 relative to the finger grip section 118 and the elongated shaft 102, the draw string mechanism 116 may be tightened thereby cinching the plastic bag of the containment vessel 114. In alternate exemplary embodiments, a cable or similar structure may be utilized as the actuation means. As cables and similar devices work in tension and not compression, pulley systems may be required to obtain the required action.

The exemplary embodiments illustrated in FIGS. 4 and 5 show simple single actuation means 400 and 500. In alternate exemplary embodiments, an actuation means may be configured to control both actions. For example, the actuation means may be configured such that drawing back the actuator handle 120 retracts the fame structure 112 while rotating the actuator handle 120 may tighten the draw string 116 thereby cinching the bag of the containment vessel 114.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A waste collection device comprising:
an elongated shaft having a first end and a second end;
a handle and actuation mechanism connected to the first end of the elongated shaft; and
a capture mechanism connected to the second end of the elongated shaft, wherein the handle and actuation mechanism is configured to control the capture mechanism.

2. The waste collection device according to claim 1, wherein the elongated shaft comprises a substantially tubular member.

3. The waste collection device according to claim 2, wherein the substantially tubular member comprises a fixed length substantially tubular member.

4. The waste collection device according to claim 2, wherein the substantially tubular member comprises an adjustable length substantially tubular member.

5. The waste collection device according to claim 1, wherein the handle and actuation mechanism comprises a grip section and an actuator handle.

6. The waste collection device according to claim 2, wherein the capture mechanism comprises a frame structure and a containment vessel.

7. The waste collection device according to claim 6, wherein the frame structure is a fixed structure.

8. The waste collection device according to claim 6, wherein the frame structure is a retractable structure configured to retract into the substantially tubular member.

9. The waste collection device according to claim 6, wherein the containment vessel is removably attached to the frame structure.

10. The waste collection device according to claim 6, wherein the containment vessel comprises a bioprotective material.

11. The waste collection device according to claim 10, wherein the bioprotective material comprise a plastic material.

12. The waste collection device according to claim 11, wherein the plastic material is scented.

13. The waste collection device according to claim 6, wherein the containment vessel is sealable.

14. The waste collection device according to claim 2, wherein the device further comprises at least one actuation means.

15. The waste collection device according to claim 14, wherein the at least one actuation means interconnects the handle and actuation means to the capture mechanism.

16. The waste collection device according to claim 15, wherein the at least one actuation means is at least partially positioned within the substantially tubular member.

17. A method for collecting waste, the method comprising the steps of:
positioning a waste collection device in proximity to an animal in the process of relieving itself, the device comprising an elongated shaft having a first end and a second end, a handle and actuation mechanism connected to the first end of the elongated shaft, and a capture mechanism connected to the second end of the elongated shaft, wherein the handle and actuation mechanism is configured to control the capture mechanism, the waste collection device being configured to capture the waste in the containment vessel before it makes contact with the ground;
sealing the containment vessel via the handle and control mechanism; and
removing the sealed containment vessel from the device for disposal.
